(19) United States
(12) Patent Application Publication
(10) Pub. No.: US 2014/0059467 A1
(43) Pub. Date: Feb. 27, 2014

(54) MOBILE DEVICE WITH GRAPHICAL USER INTERFACE FOR MONITORING A BUILDING AUTOMATION SYSTEM

(71) Applicant: TRANE INTERNATIONAL INC., Piscataway, NJ (US)

(72) Inventors: Susan M. Mairs, St. Paul, MN (US); Bryan George Kinney, Stillwater, MN (US); Kimberly Hayman, Minneapolis, MN (US); Melissa Rose Schumann, Brooklyn Park, MN (US); Rachel Michael Nilsson, Minneapolis, MN (US); Jacob Larson, Minneapolis, MN (US)

(73) Assignee: TRANE INTERNATIONAL INC., Piscataway, NJ (US)

(21) Appl. No.: 13/972,450

(22) Filed: Aug. 21, 2013

Related U.S. Application Data
(60) Provisional application No. 61/691,546, filed on Aug. 21, 2012.

(51) Int. Cl. G06F 3/0482; G06F 3/0481

(52) U.S. Cl. CPC G06F 3/0482; G06F 3/04817
USPC 715/771

(57) ABSTRACT

A mobile device with a graphical user interface for remotely monitoring and/or remotely interacting with a configurable building automation systems (BAS). In particular, the mobile device receives status data from the BAS, the graphical user interface displays the status data on the mobile device, and the graphical user interface allows a user to monitor any of the areas, including devices, associated with the BAS.

### FIELD

This disclosure generally relates to a mobile device with a graphical user interface for remotely monitoring and/or operating a building automation system.

### BACKGROUND

A Building automation system (BAS) is used to coordinate, manage, and automate control of diverse environmental, physical, and electrical building subsystems, particularly HVAC and climate control, but also including security, lighting, power, and the like.

Hardwiring and programming of a BAS can create a robust fixed system customized for a particular installation. However, monitoring and maintenance of the BAS are still generally labor-intensive tasks that vary with each system implementation. In a common scenario, a user managing a building site must be at the location of the BAS and use a computer or other device hardwired to the BAS. If there is an issue with how the BAS is operating, the user managing the building site must physically be at the BAS to monitor the issue and to resolve the issue. If the user is not physically at the BAS location and receives notification that there is an issue with the

BAS, generally, the user must physically go to the BAS location to monitor and to resolve the issue.

### SUMMARY

The embodiments described herein relate to a mobile device for interacting with a BAS remotely. Preferred embodiment relate to the mobile device for interacting with HVAC (heating, ventilation, and air conditioning) related aspects of the BAS.

The mobile device comprises a processor in communication with a memory, a network interface, and a touchscreen. The processor executes instructions for a graphical user interface (GUI) and displays the GUI on the touchscreen. The GUI a screen portion (or screen) and a navigation bar. The navigation bar includes a plurality of icons, each of the icons being associated with an interactive screen. When a user selects one of the icons of the navigation bar by touching the touchscreen, the selection is detected by the processor and the processor processes the associated interactive screen to be displayed in the screen of the GUI.

The processor is configured to receive data in real time from the BAS via the network interface. Data received in real time includes status data of the BAS or any areas associated with the BAS.

The term “area” describes, for example, but is not limited to, one or more of a component, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system. The phrase “associated with a BAS” means something that is connected to, is a part of, is controlled by, is monitored by, and/or controls the BAS.

Status data includes condition data of the area associated with the BAS. The condition data includes, but are not limited to, space temperature, space temperature setpoint, variance of space temp from setpoint, discharge air temperature, supply water or air temperature, space humidity, space power status, space light status, space airflow, and/or alarms for the space. Further, condition data includes equipment data, such as the operating information and setpoints for air handlers such as, but not limited to, duct static pressure, heating and cooling capacity, discharge air temperature and flow, and supply fan control, and for chillers such as, but not limited to, running mode, running capacity, evaporator leaving water temperature, chilled water setpoint, demand limit setpoints and active heating or cooling setpoints. Further, condition data includes system data, such as the operating information and setpoints for area systems such as, but not limited to, the same type of data as for spaces, economizing and humidity management, outdoor air conditions, optimal start conditions, night purge functions, and data about its space and equipment member participants; for chiller plant systems such as, but not limited to, chilled water data for sensors, request, return, pump, supply and cooling rate, chiller rotation schedule and priorities, and chiller operation shutdowns, lockouts, and delays, and data about its chiller equipment member participants; and for variable air systems such as, but not limited to, space temperature minimum and maximum settings, duct static optimization, ventilation optimization, calibration management, common space commands, and data about its space and air handler member participants. Further, condition data includes point data for user created points in the system such as their current value, their service state and values, the minimum and maximum values, and their alarm trigger conditions. Further, condition data includes override data for any of the above-mentioned controllable data including whether the setpoints can be overridden, are currently being overridden and at what priority level, and whether the override is permanent or will expire and at what time. Further, condition data includes schedule data including, but not limited to the schedule that is active to run at any time of any day, the normal schedule for any time and the exception schedules being applied for that time, and the transition values each time the schedule is expected to change, whether a schedule has optimization settings for start and stop times, and all the member equipment that is participating in the active schedule.

The processor can determine whether the data received is associated with a listing of one or more preselected areas stored in the memory, and the GUI displays the listing of one or more preselected areas and the data associated with the one or more preselected areas in the interactive screen.

In an embodiment, the GUI of the mobile device is configured to receive a user operation for adding a new area to the listing of one or more preselected areas by touching the touchscreen, wherein this user operation is communicated to the processor, and the new area is displayed in the screen, added to the listing of the preselected areas.

In another embodiment, the mobile device includes a GUI configured to receive a user operation to add a type of data for one more preselected areas by touching the touchscreen. That is, the GUI allows a user to select a type of information, as data, of an area that is to be displayed in the GUI. Accordingly, the GUI can display multiple icons, wherein the icons are for the same area, but each icon displays a different type of data about the area.

### BRIEF DESCRIPTION OF THE DRAWINGS

Referring now to the drawings in which like reference numbers represent corresponding parts throughout.

FIG. 1 is a cartoon diagram of a building automation system (BAS) connected to a mobile device according to one embodiment.

FIG. 2 is a schematic diagram of a mobile device according to one embodiment.

FIG. 3 is a graphical user interface diagram for a mobile device according to an embodiment.

FIG. 4 is a graphical user interface diagram for a mobile device according to an embodiment.

### DETAILED DESCRIPTION

The embodiments described herein are directed to a mobile device with a GUI for remotely monitoring and/or operating a building automation system.

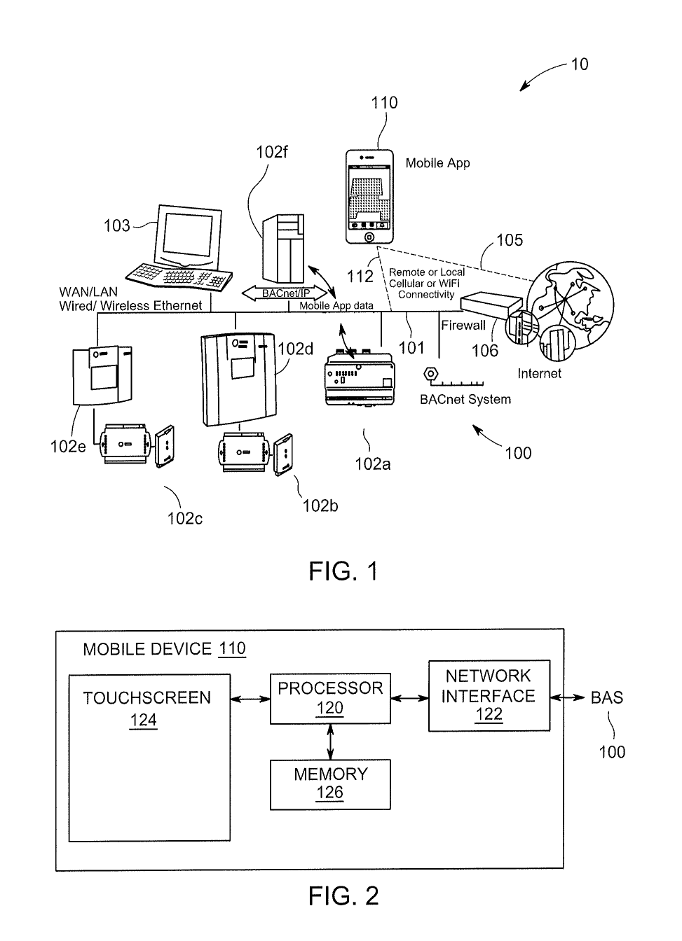

FIG. 1 shows a cartoon of a system 10 including an embodiment of a BAS 100 that includes a hardwired network 101 that uses a communication standard or protocol to link various subsystems, such as a system control unit 102a, a unit control device 102b, 102c, and/or other devices 102d, 102e, 102f, and provide a system-wide user access and control from a computer 103 hardwired to the network. The BAS 100 is connected to the internet 105, and includes a network security device 106, such as a firewall, that secures and protects the BAS 100 from unwanted intrusion via the internet 105.

The embodiment includes a mobile device 110 connectable to the BAS 100 via the internet 105, accessing the BAS 100 through the network security device 106. The mobile device 110 can connect to the BAS 100 via a local wireless connection 112. The local wireless connection 112 can be established behind the network security device 106, so that the mobile device 110 can connect to one or more of the components or devices 102a-f of the BAS 100 without requiring the communication between the mobile device 110 and the BAS 100 to go through the network security device 106.

The mobile device 110 can connect to the BAS 100 via the internet 105 using cellular, 3G, 4G, or other wireless communication protocol. The mobile device 110 can connect to the BAS 100 via the local wireless connection 112 using WiFi, bluetooth, or other wireless communication protocol. The mobile device 110 can connect to the BAS 100 using a combination of the internet 105 and local wireless connection 112.

FIG. 2 shows an illustrated schematic diagram of an embodiment of a mobile device 110. The mobile device 110 includes a processor 120 in communication with a network interface 122 and a touchscreen 124. The touchscreen 124 is a combination display and a human-computer interface device. The touchscreen 124 displays images as instructed by the processor 120. The touchscreen 124 can detect user input via touch or contact by a human finger or a stylus device, and sends the input to the processor 120. A memory 126 is in communication with the processor 120, and the memory 126 stores instructions for an operating system that is executed by the processor 120. The memory 126 can also store instructions for a computer program that is executed by the processor 120. The computer program includes a GUI for remote operation of a BAS 100.

Embodiments of the mobile device 110 include, but are not limited to, a smartphone, an iPhone, an iPad, an iPod, an Android phone, an Android tablet, a Windows phone, a Windows tablet, etc. Embodiments of the operating system include, but are not limited to, iOS, Android OS (e.g. Donut, Eclair, Gingerbread, Honeycomb, Ice Cream Sandwich, Jelly Bean, etc.), Windows, etc. Embodiments of the computer program include, but are not limited to, software for mobile device 110s commonly called an “App” or “Mobile App,” a script written in a scripting language, etc.

According to an embodiment, a GUI is displayed on the touchscreen 124 when the computer program instructions are executed by the processor 120, the GUI displays information to a user and also provides various input points for the user to interact with the GUI so that the user is allowed to provide input, such as operational commands or data request, which is sent to the processor 120. The processor 120 can then process the input according to the computer program instructions being executed and can communicate with the memory 126 and/or network interface 122 to provide data to be displayed on the touchscreen 124.

An embodiment of a computer program is stored on a computer readable medium, wherein the computer program includes computer readable instructions that can be executed by a processor 120 to display a GUI on a touchscreen 124 configured to provide data output on the touchscreen 124, and at the same time, receive operational input for remotely monitoring and/or operating a BAS 100. The data output provided can be in real time, as the data is received from the BAS 100 to the mobile device 110 via the network interface 122 of the mobile device 110.

Accordingly, a user of the mobile device 110 can be located almost anywhere and monitor and/or interact with the operation of the BAS 100, as long as the mobile device 110 can wirelessly connect to the BAS 100. Further, the mobile device 110 with the GUI displays multiple icons, wherein the icons show the area being monitored and the status of the data set by the user. This allows the user to quickly view multiple areas of the BAS 100 for monitoring multiple information of multiple devices and/or spaces in real time, as all of the data is sent from the BAS 100 to the mobile device 110 in real time.

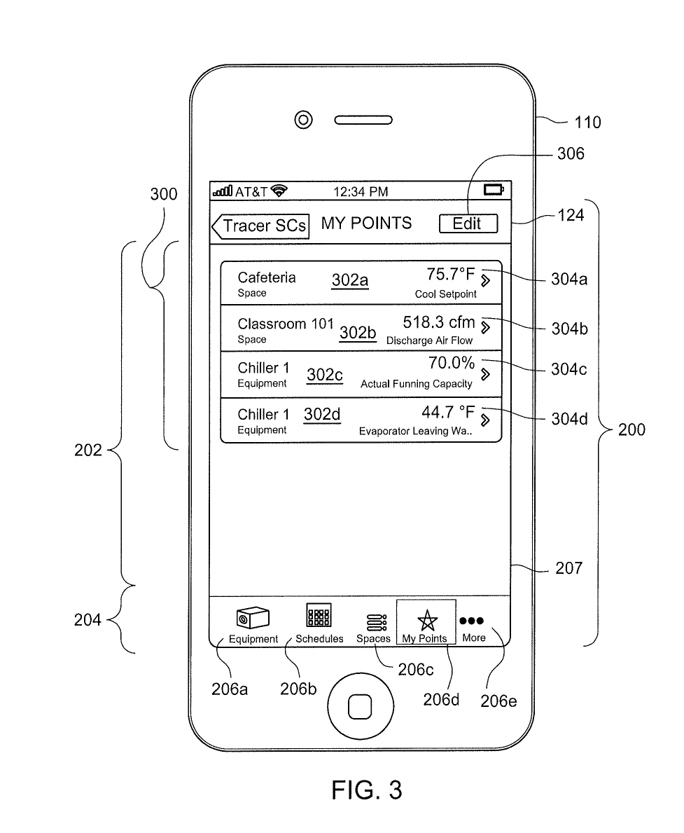

FIG. 3 shows an illustration of an embodiment of a mobile device 110 for remote operation and/or monitoring of a BAS. The mobile device 110 has a touchscreen 124 displaying a GUI 200 which includes a screen portion 202 (or screen) and a navigation bar portion (or navigation bar) 204. The navigation bar 204 includes a plurality of icons 206a, 206b, 206c, 206d, 206e, wherein each of the icons 206a-e are associated with an interactive screen, so that when one of the icons is selected by touching the touchscreen 124, the interactive screen associated with the selected icon is displayed in the screen 202 of the GUI 200. For example, FIG. 3 shows the icon 206d having been selected, and the interactive screen 207 that is associated with the icon 206d being displayed in the screen 202 of the GUI 200 on the touchscreen 124 of the mobile device 110.

It is to be understood that the term icon describes a computer generated graphic image that is used in the GUI for displaying information and/or for allowing a human to interact with the mobile device 110.

The screen 202 shows a list 300 of interactive icons 302a, 302b, 302c, 302d. Each of the icons 302a-d is associated with an area that is associated with the BAS. Icon 302a is associated with a Cafeteria space of a building that is controlled by the BAS. The data that is being received from the BAS via the network device of the mobile device 110 and processed by the processor of the mobile device 110 to be displayed as a status display 304a in the screen 202 of the GUI 200 is a temperature setpoint for cooling the Cafeteria, shown to be set at 75.7° F. If this information is somehow changed, the status display 304a will show the change. Icon 302b is associated with a Classroom space of the building that is controlled by the BAS. The data that is being received from the BAS via the network device of the mobile device 110 and processed by the processor of the mobile device 110 to be displayed as a status display 304b in the screen 202 of the GUI 200 is a discharge air flow value, shown to be at 518.3 cfm. If this information is changed, the status display 304b will show the change.

Icon 302c and Icon 302d are both associated with a Chiller equipment that is controlled by the BAS. Icon 302c shows a status display 304c as being an actual running capacity of the Chiller equipment. This is shown to be at 70.0%. If this information is changed, the status display 304c will show the change. On the other hand, Icon 302d shows a status display 304d as being an evaporator leaving water temperature of the Chiller equipment. This is shown to be at 44.7° F. If this information is changed, the status display 304d will show the change.

The GUI of the mobile device 110 is configured to receive a user operation to add or delete an area to be monitored and a type of data to be monitored. The user operation is performed by selecting the EDIT icon 306.

The icons 302a-d are selectable via touching the touchscreen 124. When one of the icons 302a-d is selected, the GUI 200 changes what is shown in the screen 202 to a status page associated with the selected icon. For example, selecting icon 302a will navigate to the Space Status page for Cafeteria, selecting icon 302b will navigate to a Space Status page for Classroom 101, and selecting on icons 302c, 302d will navigate to the Chiller Equipment Status page for Chiller 1. Thus, deeply nested information in the GUI that would generally require three or more “clicks” to access can be elevated using the GUI 200 so that the information can be accessed within two “clicks” of the GUI 200.

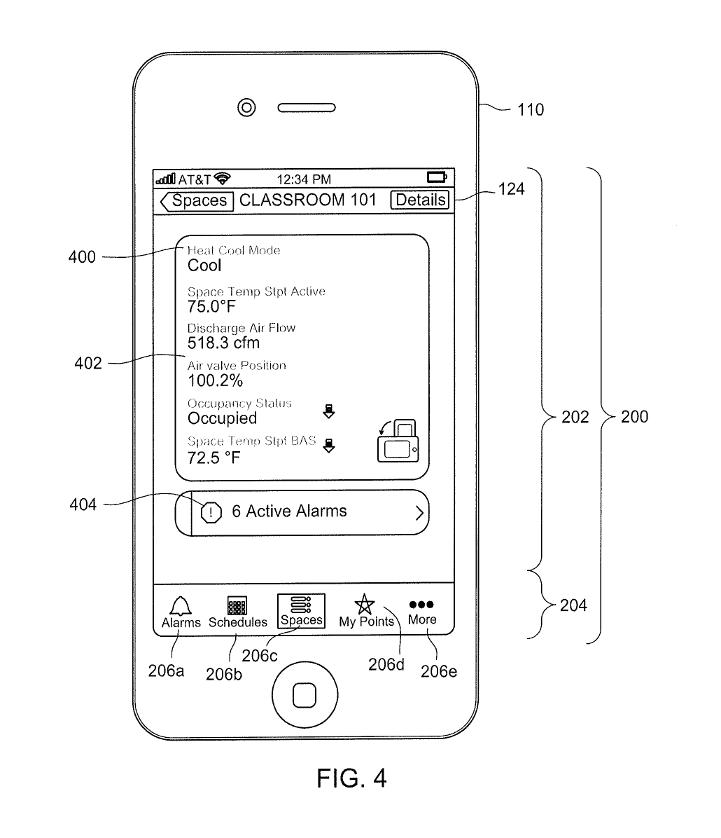

FIG. 4 shows an example of an interactive screen 400 displayed in the screen 202 of the GUI 200 for the mobile device 110 when the icon (302b) from FIG. 3 is selected. The interactive screen 400 is an example of the Space Status page for Classroom 101.

Accordingly, the interactive screen 400 shows real time conditions 402 of Classroom 101 that is an area associated with the BAS. The real time conditions 402 are from real time data sent from the BAS, received by the network interface of the mobile device 110, processed by the processor of the mobile device 110, and displayed on the touchscreen 124 of the mobile device 110 within the GUI 200. The receipt of alarm data 404 is displayed in the interactive screen 400.

Alarm data 404 includes data that reports to the mobile device 110 a particular condition of the BAS or the area that is associated with the BAS, such as, but is not limited to, one or more of a component, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system. The alarm data can include undesirable conditions of an area of a building, such as the space being too warm or too cold. The alarm data can include variance of an area's temperature from a setpoint for the area's temperature that was previously set, for example, according to the BAS's operation schedule. The alarm data can include other types of data for sending a notification to the mobile device.

Because the interactive screen 400 is one of the interactive screens accessible via the icon 206c for “Spaces,” i.e. Space Status interactive screens for areas associated with the BAS, the navigation bar 204 can show that the interactive screen 400 displayed in the screen 200 is associated with the icon 206c by highlighting the icon 206c. That is, the icon 206c is indicated visually to be different from the icons 206a, 206b, 206d, 206e that are also displayed in the navigation bar 204 of the GUI 200 to stand out therefrom.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A mobile device for remote operation of a building automation system, comprising:
a processor in communication with a memory, a network interface, and a touchscreen;
the processor executing instructions for a graphical user interface and displaying the graphical user interface on the touchscreen,
the graphical user interface includes a screen and a navigation bar, the navigation bar includes a plurality of icons, each of the icons is associated with an interactive screen, wherein a selection of one of the icons by touching the touchscreen is detectable by the processor to display in the screen the interactive screen associated with the one of the icons,
the processor is configured to receive data in real time from the building automation system via the network interface, and determine whether the data received is associated with a listing of one or more preselected areas stored in the memory, and
the graphical user interface displays the listing of one or more preselected areas and the data associated with the one or more preselected areas in the interactive screen.

2. The mobile device according to claim 1, wherein the graphical user interface is configured to receive a user operation to add a new area to the listing of one or more preselected areas by touching the touchscreen, the user operation is communicated to the processor to display in the screen the new area added to the listing of one or more preselected areas.

3. The mobile device according to claim 1, wherein the graphical user interface is configured to receive a user operation to add a type of data for one more preselected areas by touching the touchscreen, the user operation is communicated to the processor to display in the screen the data for the area in the listing of one or more preselected areas.
